(19) United States
(12) Patent Application Publication
(10) Pub. No.: US 2024/0143485 A1
(43) Pub. Date: May 2, 2024

(54) Presubmit Test Run Minimization Analysis Using Runtime Isolation Guarantees

(71) Applicant: Google LLC, Mountain View, CA (US)

(72) Inventors: Shai Barack, San Francisco, CA (US); Christopher Johnson, Mountain View, CA (US); Anirudh Mathukumill, Menlo Park, CA (US)

(21) Appl. No.: 17/973,647

(22) Filed: Oct. 26, 2022

(51) Int. Cl. G06F 11/36

(52) U.S. Cl. CPC G06F 11/3684; G06F 11/3688

(57) ABSTRACT

Presubmit testing is employed in a manner that can significantly reduce processing resources and time to validate code modules. In one aspect this includes identifying components to be subject to presubmit testing, building a set of tests for the components, analyzing the set of tests to identify any tests that are hermetic, segregating identified hermetic tests from any non-hermetic tests including identifying whether any of the hermetic tests would be affected by a current change, and performing presubmit testing on all of the non-hermetic tests and on only the hermetic tests that would be affected by the current change. For any of the components that pass the presubmit testing, those components can be stored in a code repository. Thus, if a hermetic test package is determined to be unaffected by a given change, then that test will be skipped in presubmit testing.

### BACKGROUND

A software project may include any number of modules created by one or more developers. These modules may each be written in a variety of programming languages. Before adding new or updated modules to a software build, testing is typically performed to determine whether there are potential problems with the modules. This can include evaluating whether new functionality works as intended, whether a modification breaks existing functionality, whether there is an impact on performance, etc.

One or more forms of validation testing can be done to ensure various requirements are met. On one level, this can include unit testing of individual software components. On another level, regression testing may be used to ensure that new or updated code does not unintentionally affect existing features. For large projects where there is an extensive codebase of hundreds or thousands of modules (or more), such testing may be resource intensive. This can involve significate compute resources (e.g., multiple servers to run various tests) and can take hours or longer.

### BRIEF SUMMARY

Aspects of the technology provide a software testing framework that can significantly reduce the processing resources needed and the time required to validate code modules. This may include employing a hermetic evaluator tool that is configured to resolve software components into one or more hermetic test packages. Tests that can pass in a hermetic environment may then be run in a hermetic environment, but this may be done only when a change list modifies them. If a hermetic test package is determined to be unaffected by a given change, then that test will be skipped in presubmit testing. Such an approach may significantly reduce presubmit latency and overall compute resources. It may also save non-elastic resources such as lab hardware inventory for tests that cannot be run on emulators.

According to one aspect, presubmit testing method comprising: identifying, by one or more processors of a computing system, components to be subject to presubmit testing; building, by the one or more processors, a set of tests for the components; analyzing, by the one or more processors, the set of tests to identify any tests that are hermetic; segregating, by the one or more processors, identified hermetic tests from any non-hermetic tests, including identifying whether any of the hermetic tests would be affected by a current change; performing, by the one or more processors, presubmit testing on all of the non-hermetic tests and on only the hermetic tests that would be affected by the current change; and for any of the components that pass the presubmit testing, storing those components in a code repository.

Analyzing the set of tests to identify any tests that are hermetic may include checking an indicator for a test package to confirm whether the test package is hermetic. The indicator may be associated with a component manifest file. Here, the indicator may identify a given test as being hermetic if and only if the test has no dependencies by an absolute uniform resource locator (URL) and is not associated with any external components.

Alternatively or additionally to the above, analyzing the set of tests to identify any tests that are hermetic may include determining that a given test package will be unaffected by a particular change. Alternatively or additionally to the above, analyzing the set of tests to identify any tests that are hermetic may include determining that a given component will be unaffected by a particular change. Alternatively or additionally to the above, performing the presubmit testing on all of the non-hermetic tests may include performing one or more unit tests on at least a subset of the non-hermetic tests. Alternatively or additionally to the above, identifying the components to be subject to presubmit testing may be based on receiving notification of the current change.

Alternatively or additionally to the above, analyzing the set of tests may include applying a hermetic package resolver that enforces whether given ones of the test components do not depend on any components outside of a test package. Here, the hermetic package resolver may define how component launch uniform resource locators (URLs) are translated into component declarations and namespace specifications for runtime. The hermetic package resolver may be configured to enforce whether all resolution requests are resolved within the test package. In this case, when all resolution requests cannot be resolved within the test package, the method may include the hermetic package resolver returning an error to a system package resolver.

According to another aspect, a system is provided that comprises a code repository and a computing system including one or more processors operatively coupled to the code repository. The one or more processors are configured to: identify components to be subject to presubmit testing; build a set of tests for the components; analyze the set of tests to identify any tests that are hermetic; segregate identified hermetic tests from any non-hermetic tests, including identifying whether any of the hermetic tests would be affected by a current change; perform presubmit testing on all of the non-hermetic tests and on only the hermetic tests that would be affected by the current change; and for any of the components that pass the presubmit testing, store those components in the code repository.

According to another aspect, a presubmit testing method comprises: identifying, by one or more processors of a computing system, components to be subject to presubmit testing, wherein presubmit testing comprises performance of a set of tests; analyzing, by the one or more processors, changes to the components to be subject to presubmit testing since a previous performance of presubmit testing; identifying, by the one or more processors and from the set of tests, one or more hermetic tests, any output of the one or more hermetic tests being defined solely by one or more associated hermetic test packages among the components; performing, by the one or more processors, the presubmit testing, wherein the presubmit testing includes the performance of the one or more hermetic tests only if it is determined that one or more of the changes to the components would affect the one or more hermetic tests; and for any of the components that pass the presubmit testing, storing in a code repository.

Analyzing the changes to the components to be subject to presubmit testing may include applying a hermetic package resolver that enforces whether given ones of the components do not depend on any components outside of a test package. Alternatively or additionally to the above, applying the hermetic package resolver may include evaluating corresponding component manifest files for the given components. Here, evaluating the corresponding component manifest files may include evaluating whether a hermetic key associated with a given manifest file satisfies a hermetic condition. Alternatively or additionally to the above, performing the presubmit testing may include performing one or more unit tests. Alternatively or additionally to the above, identifying the components to be subject to presubmit testing may be based on receiving notification of the changes to the components.

According to another aspect, a system is provided that comprises a code repository and a computing system including one or more processors operatively coupled to the code repository. The one or more processors are configured to: identify components to be subject to presubmit testing, wherein presubmit testing comprises performance of a set of tests; analyze changes to the components to be subject to presubmit testing since a previous performance of presubmit testing; identify, from the set of tests, one or more hermetic tests, any output of the one or more hermetic tests being defined solely by one or more associated hermetic test packages among the components: perform the presubmit testing, wherein the presubmit testing includes the performance of the one or more hermetic tests only if it is determined that one or more of the changes to the components would affect the one or more hermetic tests; and, for any of the components that pass the presubmit testing, store in the code repository.

### BRIEF DESCRIPTION OF THE DRAWINGS

FIG. 1 is a development diagram in accordance with aspects of the technology.

FIG. 2 is a workflow diagram in accordance with aspects of the technology.

FIGS. 3A-C illustrates examples for component testing in accordance with aspects of the technology.

FIG. 4 illustrates a flow diagram in accordance with aspects of the technology.

FIG. 5 illustrates a block diagram of an example computing device which can be employed in accordance with aspects of the technology.

FIGS. 6A-B illustrate a system for use with aspects of the technology.

FIG. 7 illustrates a method in accordance with aspects of the technology.

FIG. 8 illustrates another method in accordance with aspects of the technology.

### DETAILED DESCRIPTION

### Overview

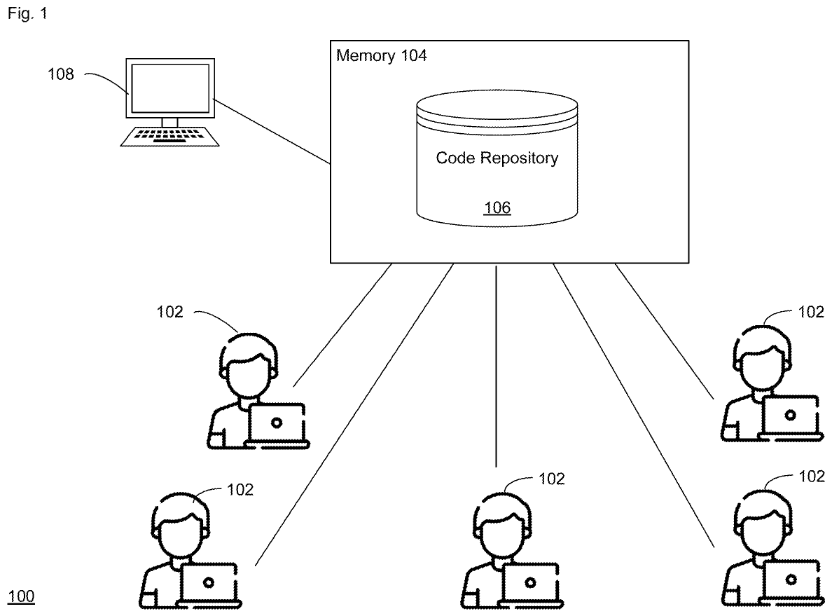

A presubmit testing framework can be used to ensure that the code for a project passes all necessary tests before being added to a code repository. The code repository may be a global repository accessible to all developers on a given team or within a company. FIG. 1 illustrates an example situation 100, in which a number of developers 102 each work on different software components. The software components may be code for an application, native applications, and/or system software to be executed by an operating system, etc. Once created, the software components can all be stored as part of the code base in memory 104, such as in a code base 106. The components may be accessible to the developers 102 and other users 108 of the code repository 106.

In one scenario, a company or a development team may employ a continuous integration approach, in which any code update may cause tests to be executed in order to identify regressions early in a software product development process. Certain tests, in particular presubmit tests, can be run prior to a change list (CL) being submitted to the code repository. By way of example, subtrees in the code repository may each contain a configuration file that determines which tests to run, and when they should be run (e.g., upon code review, immediately before submitting a CL, etc.). A presubmit test may be run synchronously prior to sending the change for review or before committing a CL to the repository. It may also be run asynchronously as warranted. Postsubmit tests may be run after the CL has been submitted. Should a presubmit test fail, then a CL may not be submitted to the repository. Postsubmit tests may be run in the background, and are often not time-sensitive.

In some situations, a distributed build system may be used to compile and link software for running tests. This can include providing a set of common commands for building and testing code and performing the testing. A computing system may distribute the work of each build across many computing devices, such as hundreds or thousands of cores or servers. According to one aspect, individual build steps may be both hermetic and deterministic. Hermetic build steps depend only on declared inputs (including the compilers invoked by the build system), which enables the build system to know all true dependencies for components. This hermeticity can ensure that the build steps are deterministic.

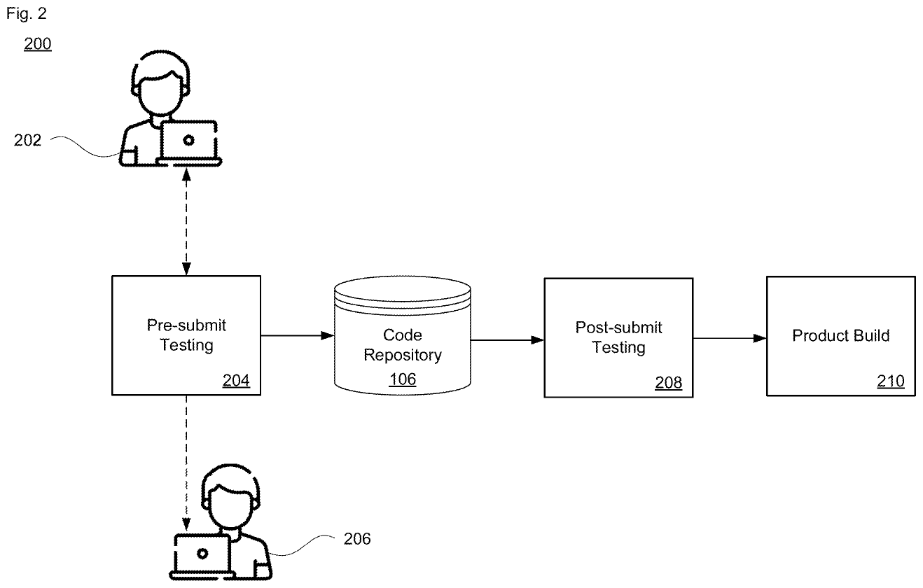

FIG. 2 illustrates an example testing workflow 200, in which one developer 202 generates a software component that is to be submitted to the code repository 106 of FIG. 1. Prior to committing a CL to the repository, presubmit testing occurs at block 204. This can include unit testing. The results of the presubmit testing may be reviewed by the developer 202. They may also be cross-checked or otherwise evaluated by another developer 206. For instance, the developer 206 may request tests to cover any changes that add new functionality.

The presubmit testing process may apply the new or updated code to corresponding portions of system software code and generate a binary of the resulting code. A build error is generated if the resulting code fails a build test. Presubmit testing may include tests to identify memory leaks, use performance profiling, perform code coverage tests, buffer overflow tests, etc. Once any issues with the software component have been addressed, the component may be stored in the repository 106. Subsequently, post-submit testing 208 may be conducted. Then at block 210 a product build can be created once the testing has been completed.

### Example Approaches

Presubmit testing, whether it includes unit tests and/or other types of tests, often requires a significant amount of compute resources and time to complete. A continuous integration approach may involve more presubmit testing than other approaches, which can be magnified when the code base is on the order of hundreds or thousands of modules or more. Thus, ways to reduce the amount of time and/or resources required provide a direct, tangible benefit to the testing system.

In some situations, machine learning, regression analysis or other statistical techniques can be used to estimate or guess which tests can be skipped. However, the consequence of not performing a test, potentially resulting in a false negative (which assumes the test would not have failed), can have significant consequences depending on the type of failure that may occur, and which would have been found in presubmit testing.

The presubmit testing framework provided herein involves analyzing new or updated code to detect which test packages would be affected by a change. The system can then perform an analysis in which a set of unaffected test packages is intersected with the set of hermetic tests. This intersection identifies hermetic tests that would be unaffected by the change. As such, the process may exclude those hermetic tests from presubmit testing. Creating test packages that omit unaffected hermetic tests can significantly reduce the amount of presubmit tests that would otherwise need to be run. For instance, according to certain experiments the presubmit test load on the testing system may be reduced by approximately 60% or more, and in some instances the test load reduction may potentially be by as much as 90%. This is a substantial reduction in the amount of processing resources that would otherwise be devoted to presubmit testing. Furthermore, the reduction in the quantity of tests necessarily results in a reduction in the amount of time (which can be viewed as latency) required to perform presubmit testing.

### Presubmit Testing

Depending on the underlying operating system architecture, a software platform may or may not incorporate runtime isolation mechanisms. For instance, when runtime isolation is employed, processes can be created with no capabilities by default, which enables a component framework to fully control the sandbox of any component to be executed by the system. In one scenario, software may be distributed by immutable, cryptographically sealed, hermetic packages. Such packages may each comprise a hierarchical collection of files providing a set of programs, components or services that can be run on a device. The package may represent a unit of distribution composed of parts, which may not be a single binary.

Components can be considered in isolation from one another if they cannot affect the other's behavior with their own behavior or presence. A test package is considered hermetic if its behavior is fully defined by the content subject to distribution, such as the files in the test package, e.g., a test program and any other assets that the test program is packaged with such as configuration files or golden files. A test component may be considered hermetic when a unit test does not depend on any other component or resources. A test component may also be considered hermetic when it only depends on other components packaged in the same test package (a hermetic test package).

When two or more tests are isolated from one another, they may be run in any order or in parallel. The system may manipulate the order to simplify sharding of test workloads given available computing resources. Parallel execution of isolated tests can reduce testing latency. Furthermore, tests that will not change as the result of other isolated tests may be skipped during testing. This can be especially beneficial because it can potentially reduce the testing load required to validate incoming changes by orders of magnitude.

In some instances, a component and its child (sub)components may reside in the same package or different packages. When the dependencies reside in the same package as the component, the component topology may be solved using relative uniform resource locators (URLs). However, when parent and child components are in separate packages but are packaged in one hermetic test package for testing purposes, a hermetic evaluator tool such as an isolated hermetic (package) resolver, can be employed. A hermetic resolver can be implemented as a service that defines how component launch URLs are translated into component declarations and sandbox/namespace specifications for runtime.

The hermetic resolver can be used to identify at build time which tests should be considered fully hermetic. The hermetic resolver enforces or otherwise ensures that test components do not depend on components outside of the test package. Then, at runtime, the system can send selected tests to an execution environment that enforces isolation and hermeticity. Here, it is important to note that any test that previously passed within the hermetic environment should continue to pass as long as the test package(s) to which it is applied has remained unmodified, and so its results can be cached. Also, any test that can pass in a hermetic environment should be run in a hermetic environment. For any tests that meet such criteria, and which may have been run previously, there is no need to re-run such tests unless there is a change in the hermetic test packages to which they are applied. According to one aspect of the technology, this may dramatically improve the efficiency and scalability of a commit queue. The amount of testing done per CL becomes proportional to the number of build targets modified by the change, instead of corresponding to the size of the codebase.

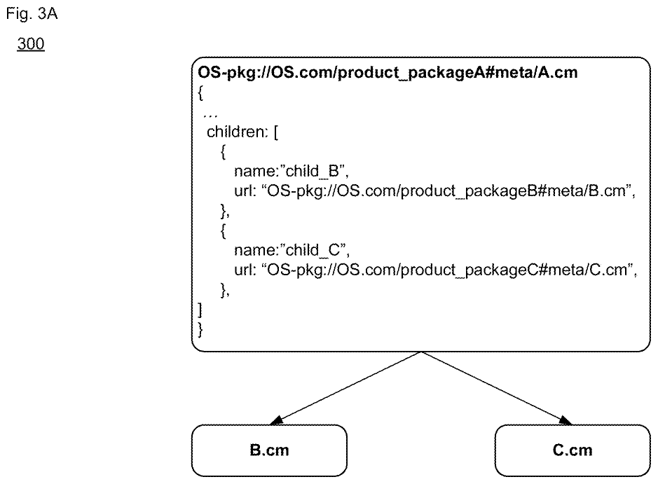

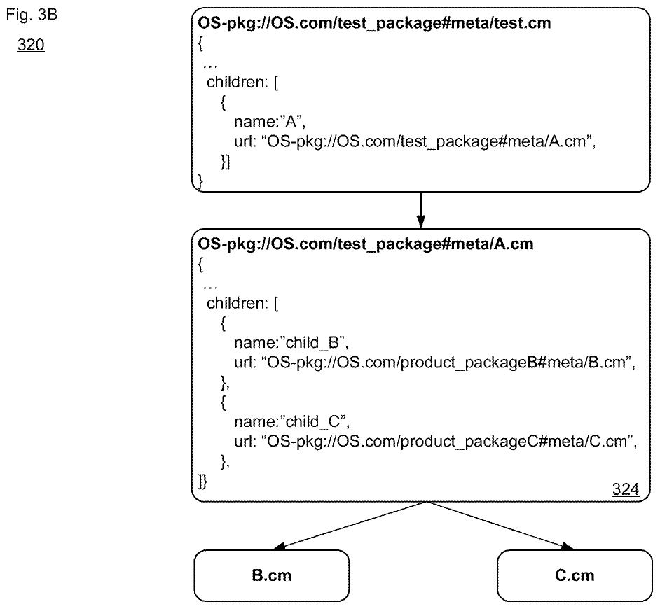

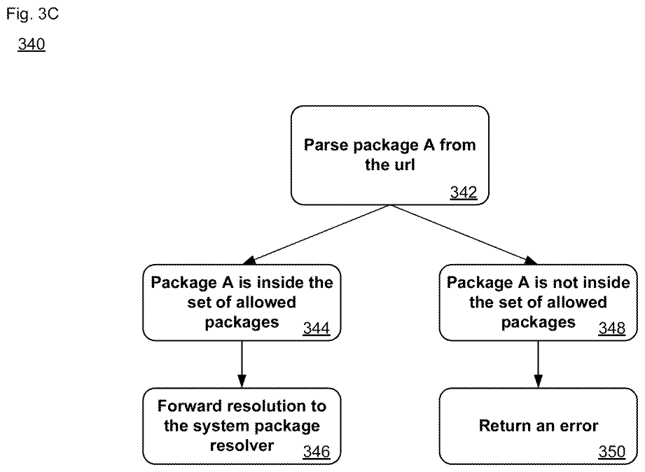

FIG. 3A illustrates an example scenario 300, in which component A.cm (where “.cm” indicates a component manifest) for a particular operating system (OS) has two child components, B.cm and C.cm. The component manifest is used to describe the structure of the particular component, e.g., the type of runtime in which to execute the component, the list of all dependencies, and any rules to manage the resources owned and used by the component. The manifest may be compiled in a binary form that uses the .cm extension. As shown, each package has its own URL. Each of the child components is part of a different package distinct from the parent package. Ideally, testing for A.cm, B.cm and C.cm should be packaged in one test package, using the manifest files for each component without any modifications. FIG. 3B illustrates a view 320 showing how test package 322 for A, B and C may be constructed

According to one aspect of the technology, a hermetic resolver will always resolve a cm file associated with a component to a predefined package ignoring the package section in the component url. The component URL contains the name of the package including the component. For example, in “OS-pkg://OS.com/test_package#metaA/tests.cm”, the name of the package containing the desired component is “testpackage”. The hermetic resolver can be injected while executing a test component so that all resolve requests from that test component are served by this isolated hermetic resolver.

In one scenario, the hermetic resolver may be a local component added to each test's sub realm, in which component resolution is scoped to a discrete set of packages including a test package, the sub-packages of the test package, and a set of allow-listed packages to address external package resolutions (which can be used to establish a regression stop). In an example, the allow list can be statically encoded, but the test package and sub-packages can dynamically change for each test package to be run.

The hermetic resolver parses this out of all requests to enforce that all resolution requests are resolved within the package. Specifically, if the resolver gets a request from some arbitrary package ‘A’, it makes sure that any requests to resolve a component are scoped to: package A, sub-packages of package A, and other allowed list packages. These 3 sets of packages form the set of allowed packages. FIG. 3C illustrates a flow 340 that indicates how a hermetic resolver may function. At block 342, it parses package A from the url. At block 344, it is determined that package A is inside the set of allowed packages. If so, at block 346 the hermetic resolver forwards resolution of the package to the system package resolver. However, when it is determined that package A is not inside the set of allowed packages at block 348, an error would return at block 350. The system package resolver is configured to perform resolution across the entire system, so the hermetic resolver can be viewed as a filter on top of it.

According to another aspect of the technology, depending on what is being packaged and whether it is hermetic, a tag, flag, label or other indicator can be associated with each test. By way of example, a test type indicator may identify a test as being hermetic or non-hermetic. Alternatively, tags could use a generated component manifest (.cm file) as a source of truth as to whether a test or a component associated with a test is hermetic. In one scenario, a hermetic key associated with a manifest may either be true or false. In this scenario, the hermetic key would be true if and only if the test is hermetically executed and packaged, having no dependencies by absolute URL and no outside capabilities.

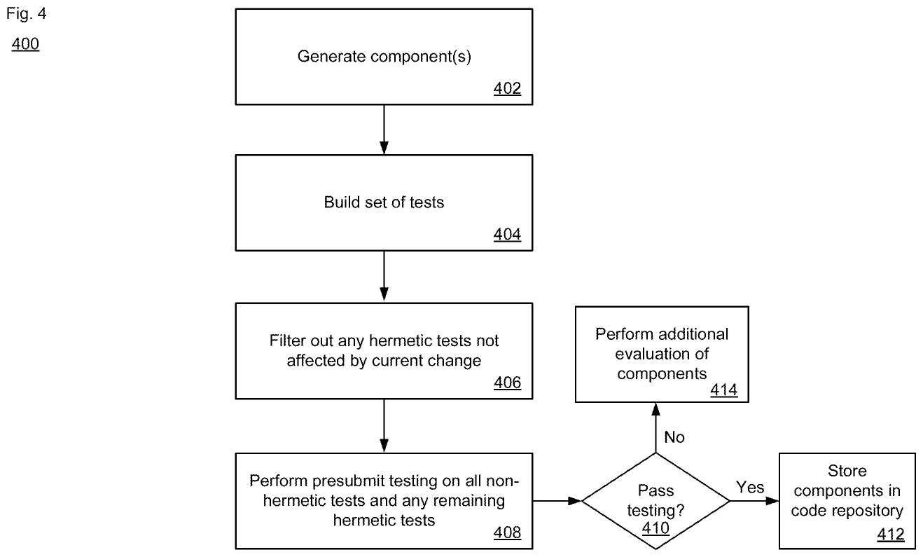

FIG. 4 illustrates an example presubmit process flow 400. At block 402, one or more components are generated by developers. At block 404 the system builds a set of tests to evaluate the components. This can include unit tests and/or other types of tests. Sharding of the tests may include selecting an order of testing, which machines will handle certain tests, etc. Once the set of tests has been built, the computing system analyzes the set to identify any hermetic tests at block 406. This may include identifying whether a given hermetic test has been previously run in an earlier presubmit testing process. The system thus filters out any hermetic tests that are not affected by a current change. The system may discard any hermetic tests previously conducted, since their results will not change.

At block 408, the system then performs presubmit testing on all non-hermetic tests and any remaining hermetic tests that are deemed to be affected by the change list. Because the hermetic tests have been flagged or otherwise excluded, there may be a significant reduction in compute resources used (e.g., this reduction could be on the order of 60% or more) and/or the time needed to conduct the presubmit testing. Then at block 410 the system evaluates whether each such test has passed. For instance, as noted above presubmit testing may include tests to identify memory leaks, use performance profiling, perform code coverage tests, buffer overflow tests, etc. If a given test passes, then the components of that test are stored in the code repository as shown at block 412. However, if the given test fails for some reason, at block 414 additional evaluation of the components may be performed, either by the developer who created the components, another developer, or automatically by the system. Once the components have been stored in the code repository, they can be implemented in build packages, such as for updates to an operating system, a feature upgrade, or a new app. The build packages can be uploaded to one or more computing devices as needed or upon request.

As noted above, some software platforms may incorporate runtime isolation mechanisms. This can provide enhanced overall security for the platform, for instance because processes can be created with no capabilities by default, which enables a component framework to fully control the sandbox of any component to be executed by the system. Other platforms may not specifically implement runtime isolation, or may not require such isolation at all. In such cases, it may be helpful to include certain requirements to ensure that certain tests are actually hermetic. By way of example, component packages may be fully defined in terms of contents using Merkle hashes or other criteria. Regardless of the approach utilized by the software platform, the above-discussed presubmit testing approach can be performed so long as the approach enables the build system to know all true dependencies for the components.

### Example Computing Devices

The technology can be applied in software assembly for applications that can be used with many different types of computing devices. This can include desktop-type computing devices, laptop-type computing devices (e.g., netbooks, tablets, etc.), mobile phones, interactive home appliances, smart televisions, etc. Once components are stored in the code repository, they may be provided to computing devices, such as part of an operating system update, feature upgrade or the like.

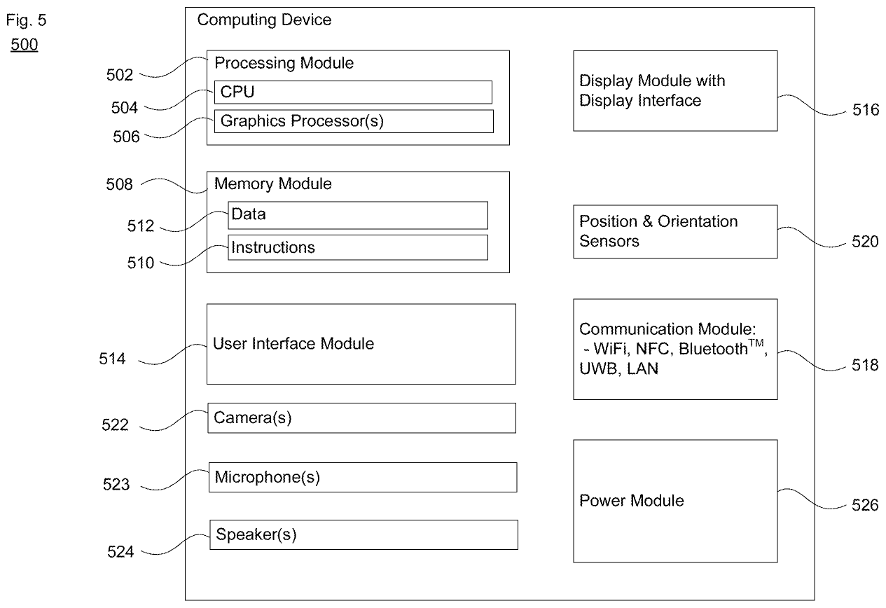

FIG. 5 illustrates a block diagram 500 of an example computing device such as a desktop-type device, laptop-type device or interactive home appliance-type device. As shown, the computing device includes a processing module 502 having one or more computer processors such as a central processing unit 504 and/or graphics processors 506, as well as memory module 508 configured to store instructions 510 and data 512, such as the components discussed above. The processors may or may not operate in parallel, and may include ASICs, controllers and other types of hardware circuitry. The processors are configured to receive information from a user through user interface module 514, and to present information to the user on a display device of the display module 516 via the user interface module. The display module 516 has a display interface and may be configured as a touchscreen that enables user input via a stylus or other tool, or by the user physically touching the screen. Alternatively or additionally, contactless gesture input and/or audio input may be supported.

User interface module 514 is configured to receive user input. User interface module 514 may receive commands from a user via user inputs and convert them for submission to a given processor. The user interface module may link to a web browser (not shown). The user inputs may include a touchscreen as noted above, in addition to or alternatively from a keyboard, keypad, mousepad and/or touchpad, microphone, gesture-based input or other types of input devices. The keyboard, keypad, mousepad and/or touchpad may be part of or connectable to the computing device via a cable or other wired connection, or may physically separate from the integrated client device and configured to connect via one or more wireless connections such as Bluetooth™, WiFi, ultra-wideband (UWB), infrared, etc. The user interface module 514 can be operatively connected to the display module 516.

The display module 516 may comprise circuitry for driving the display device to present graphical and other information to the user. In other words, the display device is configured to present visual content. By way of example, the graphical information may be generated by the graphics processor(s) 506, while central processing unit (CPU) 504 manages overall operation of the computing device. The graphical information may display responses to user queries on the display module 516. For instance, the processing module may run a browser application, gaming application, enterprise app or other service using instructions and data stored in memory module 508, and present information to the user via the display module 516. The memory module 508 may include a database or other storage for browser information, game state information, location information, etc.

Memory module 508 can be implemented as one or more of a computer-readable medium or media, a volatile memory unit or units, or a non-volatile memory unit or units. The memory module 508 may include, for example, unmanaged flash memory and/or NVRAM (which may be NAND-based memory), and may be embodied as a hard-drive or memory card such as an embedded multimedia card (eMMC) or solid state drive (SSD) card (e.g., “° managed NAND” or “managed memory”). Alternatively, the memory module 508 may also include removable media (e.g., DVD, CD-ROM or USB thumb drive). According to one aspect, the memory module 508 may be configured to have multiple partitions.

One or more regions of the memory module 508 may be write-capable while other regions may comprise read-only (or otherwise write-protected) memories. In one implementation, a computer program product is tangibly embodied in an information carrier. Although FIG. 5 functionally illustrates the processor(s), memory module, and other elements of integrated client device as being within the same overall block, such components may or may not be stored within the same physical housing. For example, some or all of the instructions and data may be stored on an information carrier that is a removable storage medium connectable to the base or the display housing (e.g., optical drive, high-density tape drive or USB drive) and others stored within a read-only computer chip which is integrated into the base or the display housing.

The data 512 may be retrieved, stored or modified by the processors in accordance with the instructions 510. For instance, the data may be stored in computing device registers, in a relational database as a table having a plurality of different fields and records, XML documents or flat files. The data may also be formatted in any computing device-readable format. The instructions 510 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in example 500 of FIG. 5, the computing device includes a communication module 518 for communicating with other devices and systems, including other computing devices (e.g., a user's mobile phone or wearable computing device), servers and databases. The communication module 518 includes a wireless transceiver; alternatively, the module may alternatively or additionally include a wired transceiver. The computing device may communicate with other remote devices via the communication module 518 using various configurations and protocols, including short range communication protocols such as near-field communication (NFC), Bluetooth™, Bluetooth™ Low Energy (BLE), UWB or other ad-hoc networks, the Internet, intranets, virtual private networks, wide area networks, local networks, private networks using communication protocols proprietary to one or more companies, Ethernet, WiFi and HTTP, and combinations of the foregoing.

In addition, the example device as shown includes one or more position and orientation sensors 520. The position and orientation sensors 520 are configured to determine the position and orientation of one or more parts of the computing device, such as the display module relative to the base. For example, these components may include a GPS receiver to estimate the integrated client device's latitude, longitude and/or altitude, as well as an accelerometer, gyroscope or another direction/speed detection device such as an inertial measurement unit (IMU) capable of determining the orientation of the display housing relative to the base (as well as the rate of change of the positioning of the display housing).

The computing device may also include one or more camera(s) 522 for capturing still images and recording video streams such as an integrated webcam and/or a dedicated imaging device for presence sensing as discussed above. The device may also include one or more microphones 523 (which can be used for instruction input and/or presence sensing, e.g., by detecting acoustic information within the threshold distance from the client device), speakers 524, as well as a power module 526. Actuators to provide tactile feedback or other information to the user may be incorporated into the touchscreen of the display module (not shown).

### Example Network

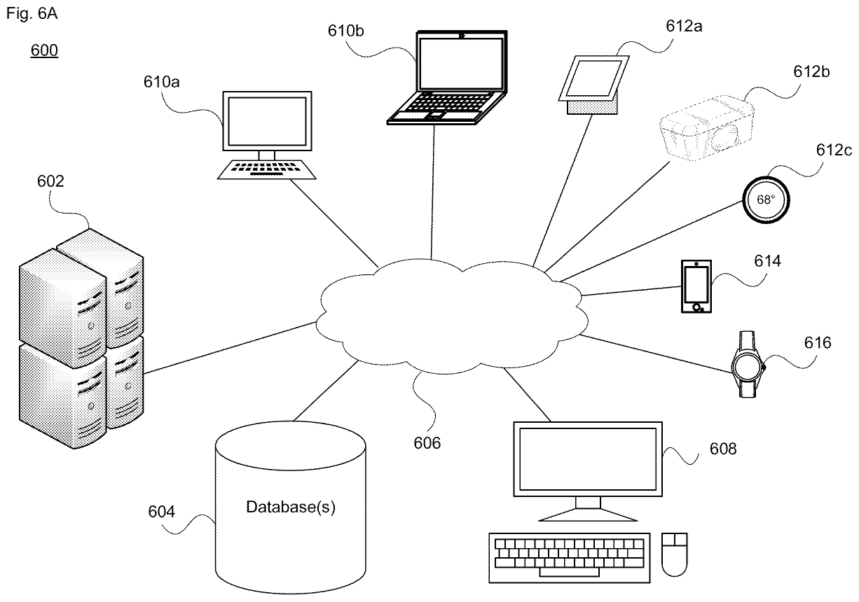

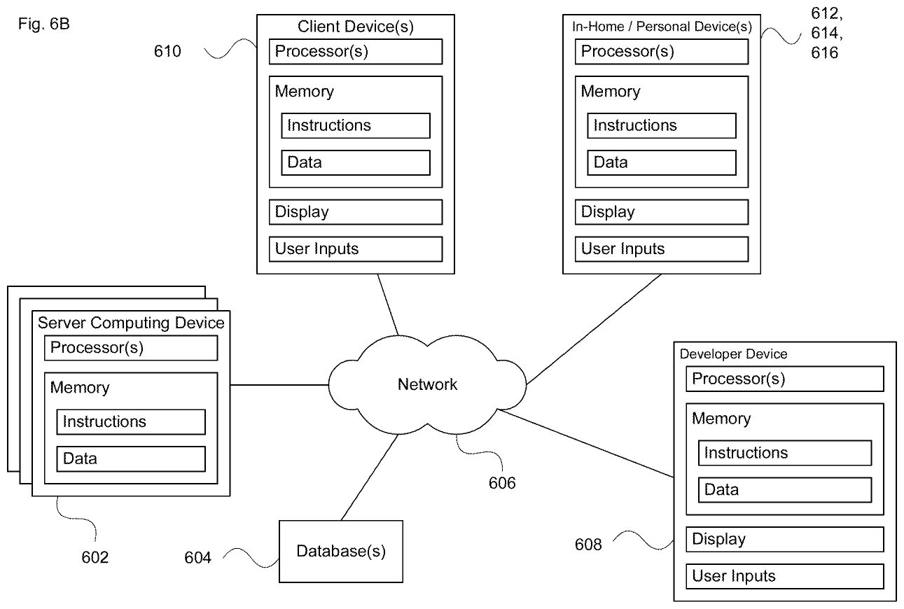

As noted above, various types of products can be updated with components that have undergone presubmit testing in the manner described. In different scenarios, updates may be performed on all devices in a product line, subsets (tranches) of devices for the product line, on multiple different product lines, etc. Or a specific app or feature can be added to a product by downloading it from the code repository or other storage system. One example computing architecture that may be employed in these approaches is shown in FIGS. 6A and 6B. In particular, FIGS. 6A and 6B are pictorial and functional diagrams, respectively, of an example system 600 that includes a plurality of computing devices and databases connected via a network. For instance, computing device(s) 602 may be a cloud-based server system that provides or otherwise supports updates for various products. Database(s) 604 may store the updates as well as other information associated with the products and/or platforms. In one example, a given database may comprise a code repository for a company or a development team. The server system may access the databases via network 606.

Computing device 608 may be a workstation or other computing device that can be used by a developer to create various components that can be added to a code repository. Products that may receive the components may include one or more of a desktop computer 610a, a laptop or tablet PC 610b, in-home devices that may include portable units (such as an at-home assistant device 612a or a smart speaker 612b), or fixed units (such as a temperature/thermostat unit 612c). Other products may include a personal communication device such as a mobile phone or PDA 614 or a wearable device 616 such as a smartwatch, etc.

In one example, computing device 602 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 602 may include one or more server computing devices that are configured to perform presubmit testing and which are capable of communicating with the develop device 608 and any of the products 610-616 via the network 606.

As shown in FIG. 6B, each of the computing devices 602, developer device 608 and products 610-616 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 6B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 602. Accordingly, references to a processor or computing device will be understood to include references to a collection of processors or computing devices or memories that may or may not operate in parallel.

The developer device 608 and the products 610-616 may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices that is operable to display information (e.g., text, imagery and/or other graphical elements). Other output devices, such as speaker(s) may also provide information to users.

The develop device 608 and/or the products 610-616 may communicate with a back-end computing system (e.g., server 602) via one or more networks, such as network 606. The network 606, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

### Exemplary Method of Operation

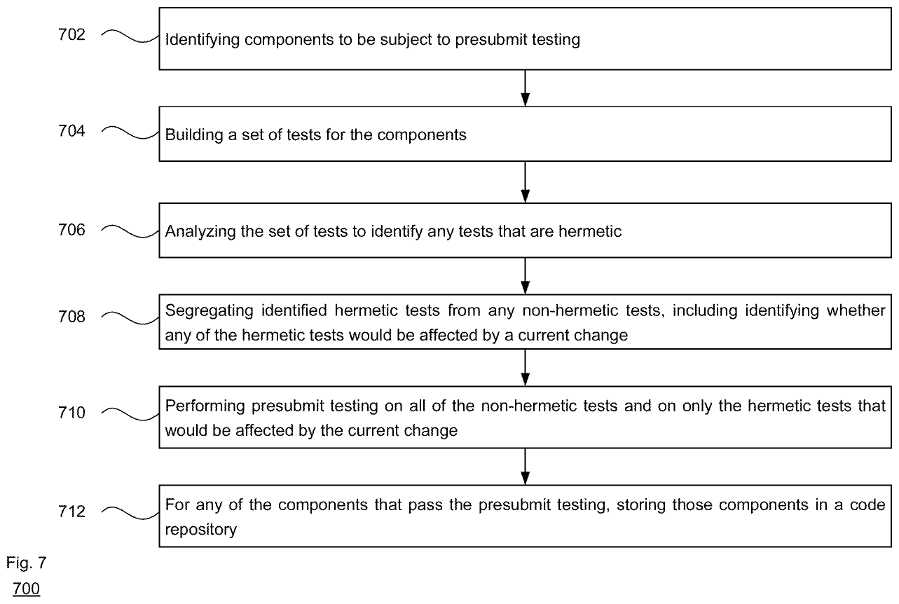

FIG. 7 illustrates an example presubmit testing method 700. At block 702, one or more processors of a computing system identify components to be subject to presubmit testing. At block 704, the method includes building, by the one or more processors, a set of tests for the components. At block 706, the method includes analyzing, by the one or more processors, the set of tests to identify any tests that are hermetic. At block 708, the method includes segregating, by the one or more processors, identified hermetic tests from any non-hermetic tests, including identifying whether any of the hermetic tests would be affected by a current change. At block 710, the method includes performing, by the one or more processors, presubmit testing on all of the non-hermetic tests and on only the hermetic tests that would be affected by the current change. And at block 712, for any of the components that pass the presubmit testing, the method includes storing those components in a code repository.

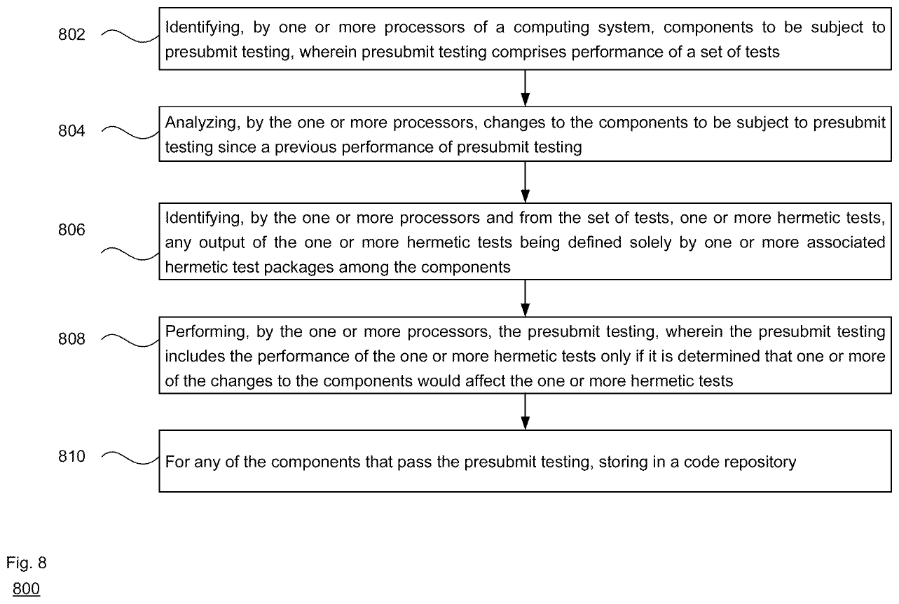

FIG. 8 illustrates a presubmit testing method 800. At block 802, the method includes identifying, by one or more processors of a computing system, components to be subject to presubmit testing, wherein presubmit testing comprises performance of a set of tests. At block 804, the method includes analyzing, by the one or more processors, changes to the components to be subject to presubmit testing since a previous performance of presubmit testing. At block 806, the method includes identifying, by the one or more processors and from the set of tests, one or more hermetic tests. Any output of the one or more hermetic tests is defined solely by one or more associated hermetic test packages among the components. At block 808, the method includes performing, by the one or more processors, the presubmit testing. This includes the performance of the one or more hermetic tests only if it is determined that one or more of the changes to the components would affect the one or more hermetic tests. And at block 810, for any of the components that pass the presubmit testing, the method includes storing in a code repository.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A presubmit testing method, comprising:
identifying, by one or more processors of a computing system, components to be subject to presubmit testing;
building, by the one or more processors, a set of tests for the components;
analyzing, by the one or more processors, the set of tests to identify any tests that are hermetic;
segregating, by the one or more processors, identified hermetic tests from any non-hermetic tests, including identifying whether any of the hermetic tests would be affected by a current change;
performing, by the one or more processors, presubmit testing on all of the non-hermetic tests and on only the hermetic tests that would be affected by the current change; and
for any of the components that pass the presubmit testing, storing those components in a code repository.

2. The method of claim 1, wherein analyzing the set of tests to identify any tests that are hermetic includes checking an indicator for a test package to confirm whether the test package is hermetic.

3. The method of claim 2, wherein the indicator is associated with a component manifest file.

4. The method of claim 2, wherein the indicator identifies a given test as being hermetic if and only if the test has no dependencies by an absolute uniform resource locator (URL) and is not associated with any external components.

5. The method of claim 1, wherein analyzing the set of tests to identify any tests that are hermetic includes determining that a given test package will be unaffected by a particular change.

6. The method of claim 1, wherein analyzing the set of tests to identify any tests that are hermetic includes determining that a given component will be unaffected by a particular change.

7. The method of claim 1, wherein performing the presubmit testing on all of the non-hermetic tests includes performing one or more unit tests on at least a subset of the non-hermetic tests.

8. The method of claim 1, wherein identifying the components to be subject to presubmit testing is based on receiving notification of the current change.

9. The method of claim 1, wherein analyzing the set of tests includes applying a hermetic package resolver that enforces whether given ones of the test components do not depend on any components outside of a test package.

10. The method of claim 9, wherein the hermetic package resolver defines how component launch uniform resource locators (URLs) are translated into component declarations and namespace specifications for runtime.

11. The method of claim 9, wherein the hermetic package resolver is configured to enforce whether all resolution requests are resolved within the test package.

12. The method of claim 11, wherein when all resolution requests cannot be resolved within the test package, the method includes the hermetic package resolver returning an error to a system package resolver.

13. A presubmit testing method, comprising:
identifying, by one or more processors of a computing system, components to be subject to presubmit testing, wherein presubmit testing comprises performance of a set of tests;
analyzing, by the one or more processors, changes to the components to be subject to presubmit testing since a previous performance of presubmit testing;
identifying, by the one or more processors and from the set of tests, one or more hermetic tests, any output of the one or more hermetic tests being defined solely by one or more associated hermetic test packages among the components;
performing, by the one or more processors, the presubmit testing, wherein the presubmit testing includes the performance of the one or more hermetic tests only if it is determined that one or more of the changes to the components would affect the one or more hermetic tests; and
for any of the components that pass the presubmit testing, storing in a code repository.

14. The method of claim 13, wherein analyzing the changes to the components to be subject to presubmit testing includes applying a hermetic package resolver that enforces whether given ones of the components do not depend on any components outside of a test package.

15. The method of claim 13, wherein applying the hermetic package resolver includes evaluating corresponding component manifest files for the given components.

16. The method of claim 15, wherein evaluating the corresponding component manifest files includes evaluating whether a hermetic key associated with a given manifest file satisfies a hermetic condition.

17. The method of claim 13, wherein performing the presubmit testing includes performing one or more unit tests.

18. The method of claim 13, wherein identifying the components to be subject to presubmit testing is based on receiving notification of the changes to the components.

19. A system, comprising:
a code repository; and
a computing system including one or more processors operatively coupled to the code repository, the one or more processors being configured to:
identify components to be subject to presubmit testing;
build a set of tests for the components;
analyze the set of tests to identify any tests that are hermetic;
segregate identified hermetic tests from any non-hermetic tests, including identifying whether any of the hermetic tests would be affected by a current change;
perform presubmit testing on all of the non-hermetic tests and on only the hermetic tests that would be affected by the current change; and
for any of the components that pass the presubmit testing, store those components in the code repository.

20. A system, comprising:
a code repository; and
a computing system including one or more processors operatively coupled to the code repository, the one or more processors being configured to:
identify components to be subject to presubmit testing, wherein presubmit testing comprises performance of a set of tests;
analyze changes to the components to be subject to presubmit testing since a previous performance of presubmit testing;
identify, from the set of tests, one or more hermetic tests, any output of the one or more hermetic tests being defined solely by one or more associated hermetic test packages among the components;
perform the presubmit testing, wherein the presubmit testing includes the performance of the one or more hermetic tests only if it is determined that one or more of the changes to the components would affect the one or more hermetic tests; and
for any of the components that pass the presubmit testing, store in the code repository.
